(19) United States
(12) Patent Application Publication
(10) Pub. No.: US 2010/0063782 A1
(43) Pub. Date: Mar. 11, 2010

(54) Finite Element Method for Simulating Combined Effects of Temperature and Thermal Residual Stress on Surface Acoustic Waves

(76) Inventors: Sangpil Yoon, Campbell, CA (US); Shigeo Kanna, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/207,329

(22) Filed: Sep. 9, 2008

(51) Int. Cl. G06F 17/11

(52) U.S. Cl. 703/2

(57) ABSTRACT

The embodiments of the present invention provide methods and systems for simulating a SAW and/or an LSAW device, while taking into account the temperature and residual stress of the device into consideration. The simulation involves transforming an equation of variational principle of elasticity into an equation of variational total potential energy with combined effects of temperature and residual stress. The transformation considers frequency-temperature relation and the effect of initial deformation caused by residual stress. The equation of variational total potential energy is then transformed into a finite element equation by considering the periodic constraints of the SAW or LSAW device. Afterwards, the finite element equation is solved to obtain eigen values and frequencies of the SAW or LSAW device. By considering the effects of stress and residual stress simultaneously during equation transformation, solving the eigen values and frequencies of the SAW or LSAW device becomes a single step process, instead of a multi-step process.

### BACKGROUND

The present invention relates generally to the simulating and analysis of surface acoustic wave (SAW) devices and, more particularly, to a method and a system of simulating a surface acoustic wave on a simulated structure.

A Surface Acoustic Wave (SAW) is a standing or traveling acoustic wave on the surface of a substrate. A typical SAW device includes a substrate (typically made from a piezoelectric material) and a periodic array of electrodes on the surface of the substrate. Piezoelectric materials deform in response to a voltage being applied to them. Piezoelectric materials also generate a voltage in response to a stress being applied to them. Leaky surface acoustic wave (LSAW) devices also have similar principles.

A SAW or an LSAW device may be simulated by numerically solving governing equations, which describe the behavior of the device. An example of such a governing equation is the equation of variational principle of elasticity. The material properties, geometry and driving voltages are very important to simulating the behavior of the SAW device.

One method of simulating a SAW or an LSAW device is to use the Finite Element (FE) method to solve the governing equations. The FE method involves creating a mesh, in which a problem domain is divided into a set of discrete sub-domains called elements. The governing equations, which describe the behavior of each element, are then solved for each element. The governing equations are typically solved numerically. The size of the mesh will determine the amount of computational time required to simulate the SAW device. The mesh elements should be small enough to effectively simulate the behavior of the SAW device, but not so small as to require an unreasonable amount of computational resources.

The current SAW and LSAW applications demand broader working-temperature spectra. Further, during the preparation of SAW devices, the substrate of the SAW devices undergoes various thermal cycling, which could introduce residual stress to the devices. As dimensions of SAW and LSAW devices become smaller and operating frequencies of these devices increase, the effects of temperature on the performance of SAW and LSAW devices becomes more prominent. Further, during device manufacturing, the SAW and/or LSAW devices are subject to thermal cycling, which could introduce residual stress on the devices.

It is in this context that embodiments of the present invention arise.

### SUMMARY

The embodiments of the present invention provide methods and systems for simulating a SAW and/or an LSAW device, while taking into account the temperature and residual stress of the device into consideration. The simulation involves transforming an equation of variational principle of elasticity into an equation of variational total potential energy with combined effects of temperature and residual stress. The transformation considers frequency-temperature relation and the effect of initial deformation caused by residual stress. In one embodiment, the residual stress is a result of thermal cycling on the SAW or LSAW device. The equation of variational total potential energy is then transformed into a finite element equation by considering the periodic constraints of the SAW or LSAW device. Afterwards, the finite element equation is solved to obtain eigen values and frequencies of the SAW or LSAW device. By considering the effects of stress and residual stress simultaneously during equation transformation, solving the eigen values and frequencies of the SAW or LSAW device becomes a single step process, instead of a multi-step process. Further, the results are more accurate due to considering the combined effects of temperature and residual stress.

It should be appreciated that the present invention can be implemented in numerous ways, including as a method, a system, or a device. Several inventive embodiments of the present invention are described below.

In one embodiment, a method for simulating a surface acoustic wave in a waveguide taking the effects of temperature and residual stress into consideration is provided. The method includes transforming an equation of variational principle of elasticity into an equation of variational total potential energy with combined effects of temperature and residual stress. The method also includes transforming the equation of variational total potential energy into a finite element (FE) equation. The method further includes simplifying the FE equation by using periodic constraints of the waveguide. In addition, the method includes solving the simplified FE equation to obtain eigen values. Additionally, the method includes calculating a frequency of the waveguide by using the obtained eigen values.

In another embodiment, a method for simulating a surface acoustic wave in a waveguide is provided. The method includes transforming an equation of variational principle of elasticity into an equation of variational total potential energy with combined effects of temperature and residual stress. The method also includes transforming the equation of variational total potential energy into a finite element (FE) equation. A static analysis is performed to obtain strain measure by following a FE procedure prior to transforming the equation of variational total potential energy into the FE equation. The method further includes simplifying the FE equation by using periodic constraints of the waveguide, and solving the simplified finite element equation to obtain eigen values. A geometry and a mesh for FE analysis of the waveguide are defined prior to solving the simplified FE equation to obtain the eigen values. In addition, the method includes calculating a frequency of the waveguide by using the obtained eigen values.

In yet another embodiment, a machine-readable medium having a program of instructions for simulating a surface acoustic wave in a waveguide with combined effects of temperature and residual stress into consideration is provided. The machine-readable medium includes program instructions for transforming an equation of variational principle of elasticity into an equation of variational total potential energy with combined effects of temperature and residual stress. The machine-readable medium also includes program instructions for transforming the equation of variational total potential energy into a finite element equation. The machine-readable medium further includes program instructions for simplifying the finite element equation by using periodic constraints of the waveguide. In addition, the machine-readable medium includes program instructions for solving the simplified finite element equation to obtain eigen values. The machine-readable medium includes program instructions for calculating a frequency of the waveguide by using the obtained eigen values.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1A shows a perspective view of a SAW device, in accordance with one embodiment of the present invention.

FIG. 1B shows a cross-sectional view of a periodic SAW device, in accordance with one embodiment of the present invention.

FIG. 2A shows an illustration of a displacement vector at two temperatures, in accordance with one embodiment of the present invention.

FIG. 2B shows a cross-sectional view of a SAW device glued to a support, in accordance with one embodiment of the present invention.

FIG. 3A shows a cross-sectional view of a periodic SAW device with dimensions, in accordance with one embodiment of the present invention.

FIG. 3B shows a cross-sectional view of one period of the SAW device, in accordance with one embodiment of the present invention.

FIG. 4 shows a method of simulating a SAW device, in accordance with one embodiment of the present invention.

FIG. 5 shows a diagram of a system for the hybrid finite element method described, in accordance with one embodiment of the present invention.

### DETAILED DESCRIPTION

An invention is described for a method and a system for simulating a surface acoustic wave (SAW) on a structure. It will be obvious, however, to one skilled in the art, that the present invention may be practiced without some or all of these specific details. In other instances, well known process operations have not been described in detail in order not to unnecessarily obscure the present invention.

As dimensions of SAW and LSAW devices become smaller and operating frequencies of these devices increase, the effects of temperature and residual stress on the performance of SAW and LSAW devices becomes more prominent. The embodiments described herein consider the effects of temperature and residual stress so that simulations of the devices more accurately reflect the actual performance.

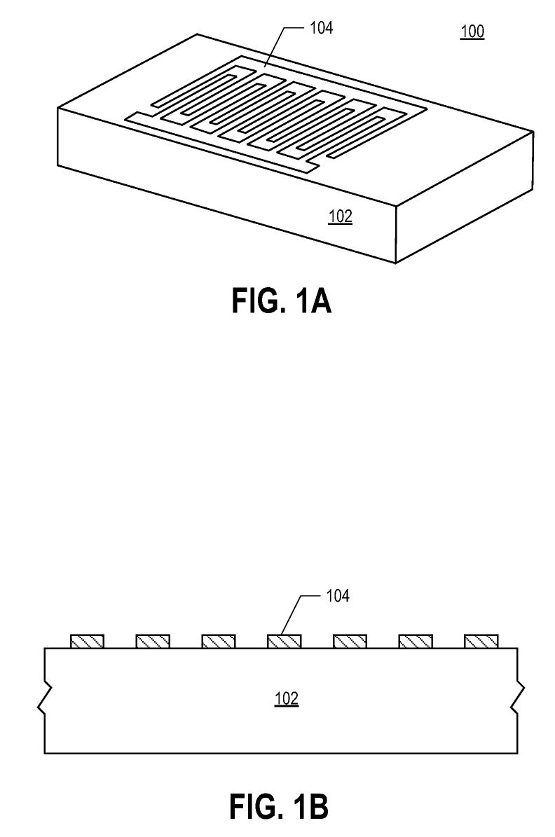

FIG. 1A shows a perspective view of a surface acoustic wave (SAW) device 100, in accordance with one embodiment of the present invention. The SAW device 100 includes a substrate 102 and a periodic array of electrodes 104 on the surface of the substrate. FIG. 1B shows a cross-sectional view of the SAW device 100, which is a waveguide, showing the substrate 102 and the periodic array of electrodes 104, in accordance with one embodiment of the present invention.

It should be noted that SAW devices can be used for a number of applications, such as filters, resonators, oscillators, etc., in electronic devices. SAW devices can have a periodic array of electrodes, as shown in FIGS. 1A and 1B. In general, the detection mechanism of a SAW device is an acoustic wave. As the acoustic wave propagates through the material of the SAW device, any changes to the characteristics of the propagation path affect the velocity and/or amplitude of the acoustic wave. Changes in velocity can be monitored by measuring the frequency or phase characteristics of the SAW device and can then be correlated to the corresponding physical quantity being measured. Applications of SAW devices include, but are not limited to, mobile communications (radio frequency filters and intermediate frequency filters), automotive applications (port resonators), medical applications (chemical sensors), and industrial and commercial applications (vapor, humidity, temperature, and mass sensors).

As mentioned above, FIG. 1B shows an embodiment of a periodic array of electrodes 104. The SAW device uses a piezoelectric material to generate the acoustic wave. It should be appreciated that piezoelectricity is the ability of certain materials to produce a voltage when subjected to mechanical stress. Conversely, the application of an electrical field creates mechanical stress in the piezoelectric material, which propagates through the SAW device 100 and is then converted back to an electric field for measurement. As shown in FIG. 1B, the SAW device 100 includes piezoelectric substrate 102, which is composed of a piezoelectric material. Exemplary piezoelectric materials include quartz (SiO₂), barium titanate (BaTiO₃), lithium tantalate (LiTaO₃), lithium niobate (LiNbO₃), gallium arsenide (GaAs), silicon carbide (SiC), langasite (LGS), zinc oxide (ZnO), aluminum nitride (AlN), lead zirconium titanate (PZT), polyvinylidene fluoride (PVdF), etc. Of course, any suitable piezoelectric material may be used for piezoelectric substrate 102. In one embodiment the piezoelectric substrate 102 is made of an anisotropic piezoelectric crystalline solid.

The SAW device 100 also includes electrodes 104 disposed on top of piezoelectric substrate 102. One skilled in the art will appreciate that electrodes 104 are made of conductive materials and are used to make contact with piezoelectric substrate 102. Exemplary electrode 104 materials include aluminum, copper, gold, conducting polymers, etc. A series of electrodes 104 disposed on top of piezoelectric substrate 102 create the alternating parallel grooves and ridges of the SAW device 100. FIG. 1B shows electrodes 104 having a rectangular shape when viewed from a side. However, electrodes 104 may have any suitable geometric shape, such as a triangle, a trapezoid, a square, etc. In one embodiment, due to the different materials being used for the electrode 104 and the substrate 102, the thermal expansion coefficients for the electrode 104 and the substrate 102 are different. The electrode 104 and the substrate 102 respond differently to the increase or decrease of temperature. Therefore, it is important to include the temperature effect in the simulation of SAW/LSAW devices.

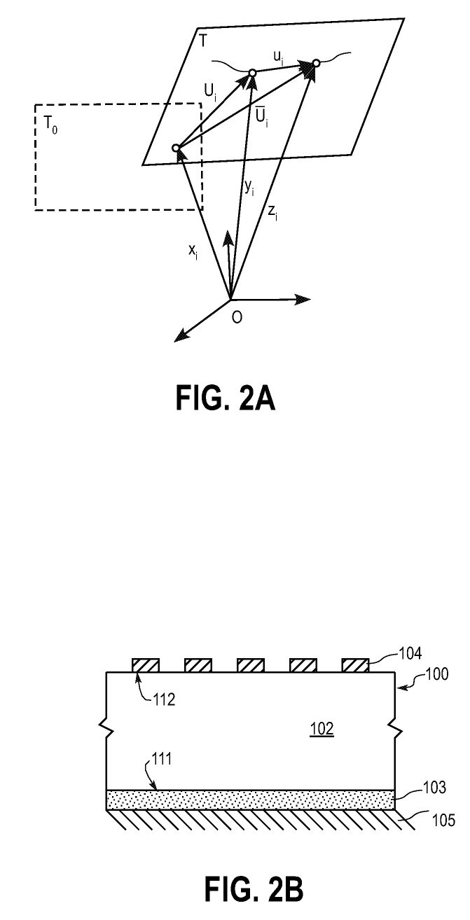

During the preparation of SAW devices, the substrate of the SAW devices undergoes various thermal cycling, which could introduce residual stress to the device. For example, the bottom of substrate 102 of device 100 is affixed to a support 105, as shown in FIG. 2B. The adhesive material 103 allows the device 100 to be attached to the support 105, which could be a board or other hard surface. High-temperature thermal processing is applied on the device 100, the adhesive material 103, and the support 105 to harden and/or to dry the adhesive material 103. In one embodiment, the adhesive material 103 is made of a butadiene polymer. In another embodiment, the adhesive material 103 is made of a silicon polymer. Adhesive material 103 can also be considered as a support for device 100. Since the electrode 104 of the device 100, the adhesive material 103 and the support 105 are made of different materials, the thermal expansion coefficients of these materials are different. Due to thermal cycling, the interface 112 between the electrode(s) 104 and the substrate 102, and the interface 111 between substrate 102 and the adhesive material 103 experience stress, which is left in the SAW device 100 as residual stress. The residual stress left in the device affects the frequency characteristics of the SAW device 100. The effects of temperature and residual stress on the frequency of SAW devices, such as SAW device 100, are described below.

### Frequency-Temperature Relation

### A. Natural State

Initially, a device, such as device 100, is assumed to be in a natural state with a uniform temperature T₀ and experiences no displacement, strain, and stress. Under such a condition, the device is considered to be at a natural state.

### B. Initial State

When the device is subjected to a steady and uniform temperature increase from T₀ to T₁, and is allowed to expand freely, the device is considered to be at an initial state. A material at position xᵢ at a natural state is displaced to a new position yᵢ, as shown in FIG. 2A. Since the temperature distribution in the crystal is uniform and steady, the heat equation is identically satisfied. The governing equations of thermoelasticity in Lagrangian formulation are reduced to the following forms:

### (a) Displacement

Uᵢ=yᵢ−xᵢ

### (b) Strain

$${E}_{i} = \frac{1}{2} ( {U}_{j , i} + {U}_{i , j} + {U}_{k , i} {U}_{k , j} )$$

### (c) Stress-Strain-Temperature Relations

$${T}_{ij} = {C}_{ijkl}^{θ} {E}_{kl} + \frac{1}{2} {C}_{ijklmn}^{θ} {E}_{kl} {E}_{mn} + \frac{1}{6} {C}_{ijklmnpq}^{θ} {E}_{kl} {E}_{mn} {E}_{pq} + \frac{1}{24} {C}_{ijklmnpqrs}^{θ} {E}_{kl} {E}_{mn} {E}_{pq} {E}_{rs} - {λ}_{ij}^{θ}$$

### (d) Stress Equations of Motion

(Tᵢⱼ+TⱼₖU_{i,k})_{,j}=ρÜᵢ=0 in V

### (e) Traction-Stress Tensor Relation

Pᵢ=nⱼ(Tᵢⱼ+TⱼₖU_{i,k}) on S (1)

where Uᵢ, Eᵢⱼ, Tᵢⱼ, and Pᵢⱼ are the initial displacement, Lagrangian strain tensor, Kirchhoff-Piola stress tensor (of second kind) and surface traction, respectively. V and S are the volume and bounding surface, respectively, of the device, which is referred to be in the natural state. nⱼ is the unit outward normal vector to S and θ, the temperature increment.

θ=T−T₀ (2)

### C. Final State

The crystal is subject to small-amplitude vibration in addition to the thermal deformation being imposed upon the initial state at the final state. The governing equations of thermoelasticity in Lagrangian formulation that correspond to equations (1) are shown below.

$${\overline{U}}_{i} = {z}_{i} - {x}_{i} \\ {{ \overline{E}}^{ }}_{i} = \frac{1}{2} ( {\overline{U}}_{j , i} + {\overline{U}}_{i , j} + {\overline{U}}_{k , i} {\overline{U}}_{k , j} ) \\ {\overline{T}}_{ij} = {C}_{ijkl}^{θ} {\overline{E}}_{kl} + \frac{1}{2} {C}_{ijklmn}^{θ} {\overline{E}}_{kl} {\overline{E}}_{mn} + \frac{1}{6} {C}_{ijklmnpq}^{θ} {\overline{E}}_{kl} {\overline{E}}_{mn} {\overline{E}}_{pq} + \frac{1}{24} {C}_{ijklmnpqrs}^{θ} {\overline{E}}_{kl} {\overline{E}}_{mn} {\overline{E}}_{pq} {\overline{E}}_{rs} - {λ}_{ij}^{θ} \\ {( {\overline{T}}_{ij} + {\overline{T}}_{jk} {\overline{U}}_{i , k} )}_{, j} = ρ {{U}^{\ddot{\_}}}_{i} in V \\ {\overline{P}}_{i} = {n}_{j} ( {\overline{T}}_{ij} + {\overline{T}}_{jk} {\overline{U}}_{i , k} ) on S \qquad ( 3 )$$

where stress coefficient of temperature, λᵢⱼ^{θ}, are temperature dependent and have the polynomial form as shown below in equation (4)

$${λ}_{ij}^{θ} = {λ}_{ij}^{( 1 )} θ + \frac{1}{2} {λ}_{ij}^{( 2 )} {θ}^{2} + \frac{1}{6} {λ}_{ij}^{( 3 )} {θ}^{3} + \frac{1}{24} {λ}_{ij}^{( 4 )} {θ}^{4} \qquad ( 4 )$$

In the above equations, the temperature field is assumed to remain T, since the vibration of temperature caused by the small vibrations is negligible.

Changes of the field quantities due to the small-amplitude vibrations are the differences between the field in the final state and the corresponding field in the initial state. The incremental displacement, strain, stress and traction are defined by equations (5) below.

$${u}_{i} = {\overline{U}}_{i} - {U}_{i} , \\ {e}_{ij} = {\overline{E}}_{ij} - {E}_{ij} , \\ {t}_{ij} = {\overline{T}}_{ij} - {T}_{ij} , \\ {p}_{i} = {\overline{P}}_{i} - {P}_{i} \qquad ( 5 )$$

By subtracting equations (1) from equations (3), respectively, and using equations (5), the governing equations of the incremental fields are shown below in equations (6).

$${e}_{ij} = \frac{1}{2} ( {u}_{j , i} + {u}_{i , j} + {U}_{k , j} {u}_{k , i} + {U}_{k , i} {u}_{k , j} ) \\ {t}_{ij} = ( \begin{matrix}{C}_{ijkl}^{θ} + {C}_{ijklmn}^{θ} {E}_{mn} + \\ \frac{1}{2} {C}_{ijklmnpq}^{θ} {E}_{mn} {E}_{pq} + \frac{1}{6} {C}_{ijklmnpqrs}^{θ} {E}_{mn} {E}_{pq} {E}_{rs}\end{matrix} ) \\ {{e}_{kl} ( {t}_{ij} + {t}_{jk} {U}_{i , k} + {T}_{jk} {u}_{i , k} )}_{, j} = ρ {\ddot{u}}_{i} in V \\ {p}_{i} = {n}_{j} ( {t}_{ij} + {t}_{jk} {U}_{i , k} + {T}_{jk} {u}_{i , k} ) on S \qquad ( 6 )$$

In the above equations, quadratic terms of incremental quantities are dropped, since the amplitude waves are considered to be relatively small. Note that equations (6) are linear in the incremental fields. When the crystal is allowed to expand freely under steady and uniform temperature increase θ(=T−T₀), the initial stress Tᵢⱼ=0, and there is no initial velocity or acceleration, i.e., \dot{U}ᵢ=Üᵢ=0. In this case, the linear thermal coefficient is shown in equation (7) below.

αᵢⱼ⁰=αᵢⱼ⁽¹⁾θ+αᵢⱼ⁽²⁾θ⁽²⁾+αᵢⱼ⁽³⁾θ³ (7)

The stress coefficient of temperature in equation (7) is easier to use than the stress coefficient of temperature given by equation (4)

By the definition of αᵢⱼ^{θ} in terms of displacement and its symmetric property, the displacement and strain can be expressed as shown in equations (8) and (9), respectively.

$$\begin{matrix}{U}_{j , i} = {U}_{i , j} = {α}_{ij}^{θ} \\ and & ( 8 ) \\ {E}_{ij} = {α}_{ij}^{θ} + \frac{1}{2} {α}_{ki}^{θ} {α}_{kj}^{θ} & ( 9 )\end{matrix}$$

initial fields from a thermal expansion due to a steady and uniform temperature increase are expressed in equations (10) below.

U_{j,i}=U_{i,j}=Eᵢⱼ=αᵢⱼ^{θ}

Tᵢⱼ=0

\dot{U}ᵢ=Üᵢ=0 (10)

Inserting equations (10) into equations (6) yields the governing equations of incremental fields superposed on a thermally induced homogeneous strain field, which are shown in Equations (11).

$${e}_{ij} = \frac{1}{2} ( {u}_{j , i} + {u}_{i , j} + {α}_{kj}^{θ} {u}_{k , i} + {α}_{ki}^{θ} {u}_{k , j} ) \\ {t}_{ij} = ( {C}_{ijkl} + {D}_{ijkl}^{( 1 )} θ + {D}_{ijkl}^{( 2 )} {θ}^{2} + {D}_{ijkl}^{( 3 )} {θ}^{3} ) {{e}_{kl} \\ ( {t}_{ij} + {α}_{ik}^{θ} {t}_{jk} )}_{, j} = ρ {\ddot{u}}_{i} in V \\ {p}_{i} = {n}_{j} ( {t}_{ij} + {α}_{ik}^{θ} {t}_{jk} ) on S \qquad ( 11 )$$

where

$${D}_{ijkl}^{( 1 )} = {C}_{ijkl}^{( 1 )} + {C}_{ijklmn} {α}_{mn}^{( 1 )} \\ {D}_{ijkl}^{( 2 )} = \frac{1}{2} {\tilde{C}}_{ijkl}^{( 2 )} + {C}_{ijklmn} {α}_{mn}^{( 2 )} \\ {D}_{ijkl}^{( 3 )} = \frac{1}{6} {\tilde{C}}_{ijkl}^{( 3 )} + {C}_{ijklmn} {α}_{mn}^{( 3 )} \qquad ( 12 )$$

where the linear thermal coefficients αᵢⱼ^{(θ)} and stain-stress temperature derivatives, such as Cᵢⱼₖₗ^{(θ)}, can be found in known tables of properties of materials.

### D. Variational Form

For a body occupying a region V with bounding surface S, the variational principle of elasticity can be expressed as follows,

$$δ {\int }_{{t}_{0}}^{{t}_{1}} ( k - λ ) d t + {\int }_{{t}_{0}}^{{t}_{1}} δ μ d t = 0 \\ k = {\int }_{V}^{ } \frac{1}{2} ρ {\dot{u}}_{i} {\dot{u}}_{i} d V \\ λ = \frac{1}{2} {t}_{kl} {e}_{kl} + {T}_{kl} {e}_{kl} \\ δ μ = {\int }_{S}^{ } {p}_{i} δ {u}_{i} d s \qquad ( 13 )$$

where t is time, k is total kinetic energy density, and λ is total strain energy density, and δμ the work done by the surface traction over S through varied displacement.

By using integration by parts and the condition that δu, vanishes at t₀ (time at natural state) and t₁ (time at initial state),

$$δ {\int }_{{t}_{0}}^{{t}_{1}} k d t = - {\int }_{{t}_{0}}^{{t}_{1}} d t {\int }_{V}^{ } ρ {\ddot{u}}_{i} δ {u}_{i} d V \qquad ( 14 )$$

By setting Tᵢⱼ=0 for zero initial stress, inserting the stress-temperature relation and the strain-displacement relation of equations (11), and using symmetric properties of tᵢⱼ and αᵢⱼ^{θ}, equation (15) can be derived.

$$\begin{matrix}δ λ = {\int }_{V}^{ } ( {t}_{ij} + {α}_{ik}^{θ} {t}_{kj} ) δ {u}_{i , j} d V \\ = {\int }_{V}^{ } \{ {[ ( {t}_{ij} + {α}_{ik}^{θ} {t}_{kj} ) δ {u}_{i} ]}_{, j} - {( {t}_{ij} + {α}_{ik}^{θ} {t}_{kj} )}_{, j} δ {u}_{i} \} d V \\ = {\int }_{S}^{ } {n}_{j} ( {t}_{ij} + {α}_{ik}^{θ} {t}_{kj} ) δ {u}_{i} d S - {\int }_{V}^{ } {( {t}_{ij} + {α}_{ik}^{θ} {t}_{kj} )}_{, j} δ {u}_{i} d V\end{matrix} \qquad ( 15 )$$

As a consequence, the equation of variational principal of elasticity (equation 13) is transformed into equation (16).

$${\int }_{{t}_{0}}^{{t}_{1}} d t {\int }_{V}^{ } [ {( {t}_{ij} + {α}_{ik}^{θ} {t}_{kj} )}_{, j} - ρ {\ddot{u}}_{j} ] δ {u}_{i} d V + {\int }_{{t}_{0}}^{{t}_{1}} d t {\int }_{S}^{ } [ {p}_{i} - {n}_{j} ( {t}_{ij} + {α}_{ik}^{θ} {t}_{kj} ) ] δ {u}_{i} d S = 0 \qquad ( 16 )$$

Since equation (16) applies to arbitrary volume and surface, the volume and surface integrals are equal to zero independently. Hence, the first and second parts of equation (16) can be expressed in equations (17) below.

$${\int }_{{t}_{0}}^{{t}_{1}} d t {\int }_{V}^{ } ( {β}_{ik} {t}_{kj , j} - ρ {\ddot{u}}_{j} ) δ {u}_{i} d v = 0 \\ {\int }_{{t}_{0}}^{{t}_{1}} d t {\int }_{S}^{ } ( {p}_{i} - {n}_{j} {β}_{ik} {t}_{kj} ) δ {u}_{i} d S = 0 \qquad ( 17 )$$

where

βᵢₖ=δᵢₖ+αᵢₖ^{θ}

αᵢⱼ^{θ}=αᵢⱼ⁽¹⁾θ+αᵢⱼ⁽²⁾θ²+αᵢⱼ⁽³⁾θ³

By applying the divergence theorem and stress-strain relations, and by noting tⱼₖβᵢₖδu_{i,j}=tⱼₖδeⱼₖ, the first part of equations (17) is transformed into equation (18). Further, the first term on the right-hand side of equation (18) is transformed into equation (19).

$$\begin{matrix}{\int }_{V}^{ } {β}_{ik} {t}_{kj , j} δ {u}_{i} d v = - {\int }_{V}^{ } {t}_{jk} {β}_{ik} δ {u}_{i , j} d v + {\int }_{S}^{ } {n}_{j} {t}_{jk} {β}_{ik} {u}_{i} d s & ( 18 ) \\ {\int }_{V}^{ } δ {e}_{ij} ( {C}_{ijkl} + {D}_{ijkl}^{( 1 )} θ + {D}_{ijkl}^{( 2 )} {θ}^{2} + {D}_{ijkl}^{( 3 )} {θ}^{3} ) {e}_{kl} d V \\ where \\ {e}_{ij} = \frac{1}{2} ( {u}_{j , i} + {u}_{i , j} + {α}_{kj}^{θ} {u}_{k , i} + {α}_{ki}^{θ} {u}_{k , j} ) = \frac{1}{2} ( {β}_{ik} {u}_{k , i} + {β}_{ik} {u}_{k , j} ) \\ and \\ {β}_{ik} = {δ}_{ik} + {α}_{ij}^{( 1 )} θ + {α}_{ij}^{( 2 )} {θ}^{2} + {α}_{ij}^{( 3 )} {θ}^{3} & ( 19 )\end{matrix}$$

Equation 19 expresses the key portion of the variational equation of the strain energy density considering temperature effect.

As mentioned above, in addition to temperature, residual stress can also affect the frequency of SAW/LSAW devices. The effect of residual stress is described below.

### Frequency-Initial Deformation (Due to Residual Stress) Relation

### A. Natural State

As mentioned above, initially a device, such as device 100, is assumed to be in a natural state and is stationary. Device 100 experiences no displacement, strain, and stress. Under such a condition, the device is considered to be at a natural state.

### B. Initial State

The device 100 experiences initial strains and/or stresses are developed in the device. As mentioned above, the initial strains could be a result of thermal cycling and different thermal expansion coefficients of materials in the device and next to the device. Under such a condition, the device is considered to be in an initial state. The governing equations of thermoelasticity in Langrangian formulation are reduced to the following forms in equation (20).

(a) Displacement

Uᵢ=yᵢ−xᵢ (20a)

### (b) Strain

$${E}_{ij} = \frac{1}{2} ( {U}_{j , i} + {U}_{i , j} + {U}_{k , i} {U}_{k , j} ) \qquad ( 20 b )$$

### (c) Stress-Strain-Temperature Relations

$${T}_{ij} = {C}_{ijkl} {E}_{kl} + \frac{1}{2} {C}_{ijklmn} {E}_{kl} {E}_{mn} \qquad ( 20 c )$$

### (d) Stress Equations of Motion

(Tᵢⱼ+TⱼₖU_{i,k})_{,j}=ρÜᵢ in V (20d)

### (e) Traction-Stress Tensor Relation

Pᵢ=nⱼ(Tᵢⱼ+TⱼₖU_{i,k}) on S (20e)

Equations (20d) and (20e) may be deduced from a variational principle for an elastic body of volume V and bounding surface S as shown in Equations (21).

$$δ {\int }_{{t}_{0}}^{{t}_{1}} d t {\int }_{V}^{ } ( K - U ) d V + {\int }_{{t}_{0}}^{{t}_{1}} d t {\int }_{S}^{ } {P}_{i} δ {U}_{i} d S = 0 \\ K = \frac{1}{2} ρ {\dot{U}}_{i} {\dot{U}}_{i} \\ U = \frac{1}{2} {C}_{ijkl} {E}_{ij} {E}_{kl} + {C}_{ijklmn} {E}_{ij} {E}_{kl} {E}_{mn} \qquad ( 21 )$$

Using Equations (20b), (20c), and (20d), and requiring δUᵢ to be zero at t₀ (time at natural state) and t₁ (time at initial state), equations (22) and (23) are derived.

$$\begin{matrix}δ {\int }_{{t}_{0}}^{{t}_{1}} d t {\int }_{V}^{ } K d V = - {\int }_{{t}_{0}}^{{t}_{1}} d t {\int }_{V}^{ } ρ {\ddot{U}}_{i} δ {U}_{i} d V \\ and & ( 22 ) \\ δ {U}_{i} = \frac{\partial U}{\partial {E}_{ij}} δ {E}_{ij} = {T}_{ij} {β}_{kj} δ {U}_{k , i} & ( 23 )\end{matrix}$$

where βᵢⱼ the initial deformation gradient, is given by equation (24) below.

$${β}_{ij} = \frac{{y}_{i}}{{x}_{j}} = {δ}_{ij} + {U}_{i , j} \qquad ( 24 )$$

Substituting equations (22) and (23) into (21) and using divergence theorem, equation (25) is derived.

∫₀¹dt∫[(Tᵢⱼβₖⱼ)ⱼ−ρÜₖ]δUₖdV+∫₀¹dt∫_{S}(Pₖ−nᵢTᵢⱼβₖⱼ)δUₖdS=0 (25)

### C. Final State

At this state, the device is subjected to a small-amplitude vibration in addition to the initial deformations being imposed upon the initial state. The incremental displacement uᵢ, strain eᵢⱼ, stress tᵢⱼ, traction pᵢ, kinetic energy density k, and strain energy density u are defined, respectively, by equations (26).

$$\begin{matrix}{e}_{ij} = \frac{1}{2} ( {u}_{j , i} + {u}_{i , j} + {U}_{k , j} {u}_{k , i} + {U}_{k , i} {u}_{k , j} ) = \frac{1}{2} ( {β}_{kj} {u}_{k , i} + {β}_{ki} {u}_{k , j} ) & ( 26 a ) \\ {t}_{ij} = ( {C}_{ijkl} + {C}_{ijklmn} {E}_{mn} ) {e}_{kl} & ( 26 b ) \\ k = \frac{1}{2} ρ {\dot{u}}_{i} {\dot{u}}_{i} + \frac{1}{2} ρ {\dot{U}}_{i} {\dot{u}}_{i} & ( 26 c ) \\ \begin{matrix}u = \frac{1}{2} ( {C}_{ijkl} + {C}_{ijklmn} {E}_{mn} ) {e}_{ij} {e}_{kl} + ( {C}_{ijkl} + \frac{1}{2} {C}_{ijklmn} {E}_{mn} ) {E}_{ij} {e}_{kl} \\ = \frac{1}{2} {t}_{kl} {e}_{kl} + {T}_{kl} {e}_{kl}\end{matrix} & ( 26 d ) \\ {( {t}_{jk} {β}_{ik} )}_{, j} = ρ {\ddot{u}}_{i} in V & ( 26 e ) \\ {p}_{i} = {n}_{j} {t}_{jk} {β}_{ik} on S & ( 26 f )\end{matrix}$$

In equations (26) the quadratic terms u_{k,j} u_{k,j} and eₖₗ eₘₙ are dropped, since they are relatively small in comparison to the first-order terms u_{k,j} and eₖₗ due to small-amplitude vibrations. Note that among the initial fields Uᵢ, Eᵢⱼ, and Tᵢⱼ, which are solutions of equation (20), only Eᵢⱼ and βᵢⱼ, the deformation gradients, appear explicitly in the incremental field equations in (26) as known functions. In the case that no initial deformation and no initial velocities exist, i.e., βᵢⱼ=δᵢⱼ and Eᵢⱼ=Tᵢⱼ=\dot{U}ᵢ=0. Equations (26) are reduced to formulations of linear elasticity.

### D. Variational Form

When ūᵢ is the virtual incremental displacement and ēᵢⱼ is the virtual incremental strain, their relationship is shown in equation (27).

$${\overline{e}}_{ij} = \frac{1}{2} ( {β}_{kj} {\overline{u}}_{k , i} + {β}_{ki} {\overline{u}}_{k , j} ) \qquad ( 27 )$$

Multiplying (26e) by ūᵢ and integrating the product over a volume V bounded by surface S, the principal of elasticity is transformed to equation (28).

$${\int }_{V}^{ } ⌊ {( {t}_{jk} {β}_{ik} )}_{, j} - ρ {\ddot{u}}_{i} ⌋ {\overline{u}}_{i} d V = 0 \qquad ( 28 )$$

By using the divergence theorem and stress-strain relations, and by noting tⱼₖβᵢⱼū_{i,j}=tᵢₖēⱼₖ, equation (28) is transformed into equation (29). Equation (29) can also be expressed as equation (30).

$$\begin{matrix}- {\int }_{V}^{ } {t}_{jk} {β}_{ik} {\overline{u}}_{i , j} d V + {\int }_{S}^{ } {n}_{j} {t}_{jk} {β}_{ik} {\overline{u}}_{i} d S - {\int }_{V}^{ } ρ {\ddot{u}}_{i} {\overline{u}}_{i} d V = 0 & ( 29 ) \\ {\int }_{V}^{ } {\overline{e}}_{ij} ( {C}_{ijkl} + {C}_{ijklmn} {E}_{mn} ) {e}_{kl} d V = {\int }_{S}^{ } p {\overline{u}}_{i} d S - {\int }_{V}^{ } ρ {\ddot{u}}_{i} {\overline{u}}_{i} d V \\ where \\ {e}_{ij} = \frac{1}{2} ( {u}_{j , i} + {u}_{i , j} + {U}_{k , j} {u}_{k , i} + {U}_{k , i} {u}_{k , j } ) = \frac{1}{2} ( {β}_{kj} {u}_{k , i} + {β}_{ki} {u}_{k , j} ) \\ and \\ {β}_{ij} = {δ}_{ij} + {U}_{i , j} & ( 30 )\end{matrix}$$

The equation in the left side of equation (30), which includes Eₘₙ, expresses the key components of variational equation of the strain energy density including the effect of initial strains due to residual stress.

Based on the derivation above, by combining the temperature effect and the effect of initial strains due to residual stress, the energy density and its variational form can be directly implemented in FE analysis, and can be written as equation (31).

$$\partial Ψ = {\int }_{V}^{ } [ \begin{matrix}δ {e}_{ij} ( {C}_{ijkl} + {D}_{ijkl}^{( 1 )} θ + {D}_{ijkl}^{( 2 )} {θ}^{2} + {D}_{ijkl}^{( 3 )} {θ}^{3} ) {e}_{kl} + \\ δ {\overline{e}}_{kl} {C}_{ijklmn} {E}_{mn} {\overline{e}}_{kl}\end{matrix} ] d V \\ {e}_{ij} = \frac{1}{2} ( {u}_{j , i} + {u}_{i , j} + {α}_{kj}^{θ} {u}_{k , i} + {α}_{ki}^{θ} {u}_{k , j} ) \\ where \\ {\overline{e}}_{ij} = \frac{1}{2} ( {u}_{j , i} + {u}_{i , j} + {U}_{k , j} {u}_{k , i} + {U}_{k , i} {u}_{k , j } ) \qquad ( 31 )$$

The matrix equation can be obtained by following the finite element (FE) approximation. The process of obtaining the matrix equation can be described as following. Based on equation (31), the first strain measure eᵢⱼ can be rewritten as equation (32).

$$\begin{matrix}{e}_{ij} = \frac{1}{2} ( {β}_{ik} {u}_{k , i} + {β}_{ik} {u}_{k , j} ) \\ with \\ {β}_{ik} = {δ}_{ik} + {α}_{ik}^{θ} & ( 32 ) \\ {e}_{11} = \frac{1}{2} ( \begin{matrix}{u}_{1 , 1} + {α}_{k 1}^{θ} {u}_{k , 1} + \\ {u}_{1 , 1} + {α}_{k 1}^{θ} {u}_{k , 1}\end{matrix} ) = {u}_{1 , 1} + {β}_{1 k} {u}_{k , 1} = {β}_{1 k} {u}_{k , 1} \\ {e}_{22} = \frac{1}{2} ( \begin{matrix}{u}_{2 , 2} + {α}_{k 2}^{θ} {u}_{k , 2} + \\ {u}_{2 , 2} + {α}_{k 2}^{θ} {u}_{k , 2}\end{matrix} ) = {u}_{2 , 2} + {β}_{2 k} {u}_{k , 2} = {β}_{2 k} {u}_{k , 2} \\ {e}_{33} = \frac{1}{2} ( \begin{matrix}{u}_{3 , 3} + {α}_{k 3}^{θ} {u}_{k , 3} + \\ {u}_{3 , 3} + {α}_{k 3}^{θ} {u}_{k , 3}\end{matrix} ) = {u}_{3 , 3} + {β}_{3 k} {u}_{k , 3} = {β}_{3 k} {u}_{k , 3} \\ 2 {e}_{23} = ( {u}_{3 , 2} + {α}_{k 3}^{θ} {u}_{k , 2} ) + ( {u}_{2 , 3} + {α}_{k 2}^{θ} {u}_{k , 3} ) = {β}_{3 k} {u}_{k , 2} + {β}_{2 k} {u}_{k , 3} \\ 2 {e}_{13} = ( {u}_{3 , 1} + {α}_{k 3}^{θ} {u}_{k , 1} ) + ( {u}_{1 , 3} + {α}_{k 1}^{θ} {u}_{k , 3} ) = {β}_{3 k} {u}_{k , 1} + {β}_{1 k} {u}_{k , 3} \\ 2 {e}_{12} = ( {u}_{2 , 1} + {α}_{k 2}^{θ} {u}_{k , 1} ) + ( {u}_{1 , 2} + {α}_{k 1}^{θ} {u}_{k , 2} ) = {β}_{2 k} {u}_{k , 1} + {β}_{1 k} {u}_{k , 2} & ( 33 )\end{matrix}$$

The nodal displacement, {u}={uₓ u_{y} u_{z}}^{T}, at an arbitrary point within a finite element is interpolated from nodal degree of freedom {u}ₑ by following {u}^{T}=[N]{u}ₑ^{T}, where [N] is the shape function matrix. A matrix form of strain e can be expressed as equation (34).

{e}=[B]{u}ₑ^{T} (34)

where

$${\{ e \}}^{T} = \{ \begin{matrix}{e}_{11} & {e}_{22} & {e}_{33} & {e}_{23} & {e}_{13} & {e}_{12} \}\end{matrix} \\ {B}^{T} = [ \begin{matrix}\frac{\partial N}{\partial x} {β}_{11} & 0 & \frac{\partial N}{\partial z} {β}_{31} & \frac{\partial N}{\partial z} {β}_{21} & ( \begin{matrix}\frac{\partial N}{\partial z} {β}_{11} + \\ \frac{\partial N}{\partial x} {β}_{31}\end{matrix} ) & \frac{\partial N}{\partial x} {β}_{21} \\ \frac{\partial N}{\partial x} {β}_{12} & 0 & \frac{\partial N}{\partial z} {β}_{32} & \frac{\partial N}{\partial z} {β}_{22} & ( \begin{matrix}\frac{\partial N}{\partial z} {β}_{12} + \\ \frac{\partial N}{\partial x} {β}_{32}\end{matrix} ) & \frac{\partial N}{\partial x} {β}_{22} \\ \frac{\partial N}{\partial x} {β}_{13} & 0 & \frac{\partial N}{\partial z} {β}_{33} & \frac{\partial N}{\partial z} {β}_{23} & ( \begin{matrix}\frac{\partial N}{\partial z} {β}_{13} + \\ \frac{\partial N}{\partial x} {β}_{33}\end{matrix} ) & \frac{\partial N}{\partial x} {β}_{23}\end{matrix} ] \\ {\{ u \}}_{e} = \{ \begin{matrix}{u}_{x} & {u}_{y} & {{u}_{z} \}}_{e}\end{matrix}$$

Also based on equation (31), the matrix form of the second strain measure, ēᵢⱼ, is shown in equation (35).

$$\begin{matrix}{\overline{e}}_{ij} = \frac{1}{2} ( {F}_{kj} {u}_{k , i} + {F}_{ki} {u}_{k , j} ) \\ where \\ {F}_{ij} = \frac{{y}_{i}}{{x}_{j}} = {δ}_{ij} + {U}_{i , j} \\ Therefore , & ( 35 ) \\ {\overline{e}}_{11} = {F}_{k 1} {u}_{k , 1} = {F}_{11} {u}_{1 , 1} + {F}_{21} {u}_{2 , 1} + {F}_{31} {u}_{3 , 1} \\ {\overline{e}}_{22} = {F}_{k 2} {u}_{k , 2} = {F}_{12} {u}_{1 , 2} + {F}_{22} {u}_{2 , 2} + {F}_{32} {u}_{3 , 2} \\ {\overline{e}}_{33} = {F}_{k 3} {u}_{k , 3} = {F}_{13} {u}_{1 , 3} + {F}_{23} {u}_{2 , 3} + {F}_{33} {u}_{3 , 3} \\ 2 {\overline{e}}_{23} = {F}_{k 3} {u}_{k , 2} + {F}_{k 2} {u}_{k , 3} = {F}_{12} {u}_{1 , 3} + {F}_{22} {u}_{2 , 3} + {F}_{32} {u}_{3 , 3} \\ \begin{matrix}2 {\overline{e}}_{13} = {F}_{k 3} {u}_{k , 1} + {F}_{k 1} {u}_{k , 3} \\ = ( {F}_{13} {u}_{1 , 1} + {F}_{23} {u}_{2 , 1} + {F}_{33} {u}_{3 , 1} ) + ( {F}_{11} {u}_{1 , 3} + {F}_{21} {u}_{2 , 3} + {F}_{31} {u}_{3 , 3} ) \\ = ( {F}_{11} {u}_{1 , 3} + {F}_{13} {u}_{1 , 1} ) + ( {F}_{21} {u}_{2 , 3} + {F}_{23} {u}_{2 , 1} ) + ( {F}_{31} {u}_{3 , 3} + {F}_{33} {u}_{3 , 1} ) \\ 2 {\overline{e}}_{12} = {F}_{k 1} {u}_{k , 2} + {F}_{k 2} {u}_{k , 1} = {F}_{12} {u}_{1 , 1} + {F}_{22} {u}_{2 , 1} + {F}_{32} {u}_{3 , 1}\end{matrix} & ( 36 )\end{matrix}$$

Introducing the FE approximation of displacement transforms equation (36) into a matrix form of the strain measure of equation (37).

{ē}=[ B̅]{u}ₑ^{T} (37)

where

$${\{ \overline{e} \}}^{T} = \{ \begin{matrix}{\overline{e}}_{11} & {\overline{e}}_{22} & {\overline{e}}_{33} & {\overline{e}}_{23} & {\overline{e}}_{13} & {\overline{e}}_{12} \}\end{matrix} \\ {\overline{B}}^{T} = [ \begin{matrix}\frac{\partial N}{\partial x} {F}_{11} & 0 & \frac{\partial N}{\partial z} {F}_{13} & \frac{\partial }{\partial z} {F}_{12} & ( \begin{matrix}\frac{\partial N}{\partial z} {F}_{11} + \\ \frac{\partial N}{\partial x} {F}_{13}\end{matrix} ) & \frac{\partial N}{\partial x} {F}_{21} \\ \frac{\partial N}{\partial x} {F}_{21} & 0 & \frac{\partial N}{\partial z} {F}_{23} & \frac{\partial }{\partial z} {F}_{22} & ( \begin{matrix}\frac{\partial N}{\partial z} {F}_{21} + \\ \frac{\partial N}{\partial x} {F}_{23}\end{matrix} ) & \frac{\partial N}{\partial x} {F}_{22} \\ \frac{\partial N}{\partial x} {F}_{31} & 0 & \frac{\partial N}{\partial z} {F}_{33} & \frac{\partial }{\partial z} {F}_{32} & ( \begin{matrix}\frac{\partial N}{\partial z} {F}_{31} + \\ \frac{\partial N}{\partial x} {F}_{33}\end{matrix} ) & \frac{\partial N}{\partial x} {F}_{23}\end{matrix} ]$$

The variational equation of motion with equation (31) can be formulated into equation (38) below. Π in equation (38) is the total potential energy.

$$\begin{matrix}0 = \partial Π \\ = {\int }_{V}^{ } [ \begin{matrix}δ {e}_{ij} ( {C}_{ijkl} + {D}_{ijkl}^{( 1 )} θ + {D}_{ijkl}^{( 2 )} {θ}^{2} + {D}_{ijkl}^{( 3 )} {θ}^{3} ) {e}_{kl} + \\ δ {\overline{e}}_{kl} {C}_{ijklmn} {E}_{mn} {\overline{e}}_{kl}\end{matrix} ] d V - \\ {\int }_{V}^{ } {w}^{2} {u}_{i} δ {u}_{i} d V\end{matrix} \qquad ( 38 )$$

The FE matrix form of a piezoelectric medium is directly given as equation (39) below.

([K]−w²[M]){U}=0 (39)

where {U} is a displacement vector, w is the angular frequency, [K] is a mechanical stiffness matrix. [K] can be expressed as equation (40). [M] is a mechanical mass matrix and is expressed as equation (41).

$$\begin{matrix}[ K ] = {\int }_{V}^{ } {[ B ]}^{T} [ C ] [ B ] d V + {\int }_{V}^{ } {[ \overline{B} ]}^{T} [ \overline{C} ] [ \overline{B} ] d V & ( 40 ) \\ [ M ] = {\int }_{V}^{ } {ρ [ N ]}^{T} [ N ] d V & ( 41 )\end{matrix}$$

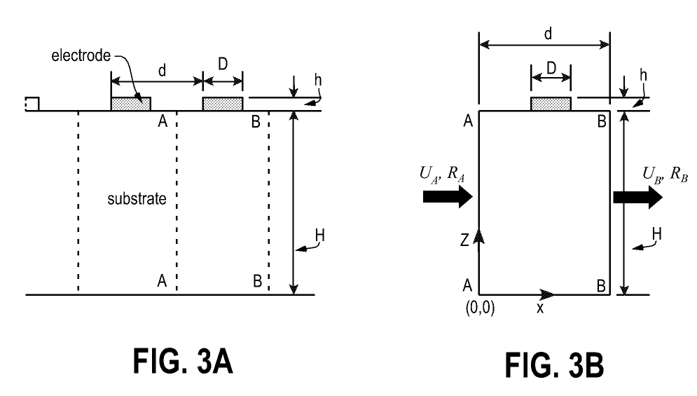

FIG. 3A shows a cross-sectional drawing of a periodic SAW structure with electrodes and a substrate. The width of a period of the SAW device is d, the width of the electrode is D, the thickness of the electrode is h, and the thickness of the substrate is H. The boundaries of a period of SAW device are represented by boundary lines AA and BB. FIG. 3B shows a period of the SAW device. The lower left corner of substrate is (0,0) position for x-axis and z-axis.

On the boundary AA, there are displacement U_{A} and force R_{A}. On boundary BB, there are displacement U_{B} and force R_{B}, which are equivalent to the displacement U_{A} and force R_{A} on AA due to the repeating structures. By considering the periodic condition (or periodic constraints), equation (40) can be transformed into equation (42) with displacement vector, U_{A} and U_{B}, and reaction force, R_{A} and R_{B}.

$$[ \begin{matrix}{K}_{II} & {K}_{IA} & {K}_{IB} \\ {K}_{AI} & {K}_{AA} & {K}_{AB} \\ {K}_{BI} & {K}_{BA} & {K}_{BB}\end{matrix} ] [ \begin{matrix}{U}_{I} \\ {U}_{A} \\ {U}_{B}\end{matrix} ] = {w}^{2} [ \begin{matrix}{M}_{II} & {M}_{IA} & {M}_{IB} \\ {M}_{AI} & {M}_{AA} & {M}_{AB} \\ {M}_{BI} & {M}_{BA} & {M}_{BB}\end{matrix} ] [ \begin{matrix}{U}_{I} \\ {U}_{A} \\ {U}_{B}\end{matrix} ] + [ \begin{matrix}O \\ {R}_{A} \\ {R}_{B}\end{matrix} ] \qquad ( 42 )$$

where the subscript A and B denote nodal degree of freedom on interface boundaries AA and BB, respectively, and the subscript I denotes all remaining degree of freedom. The nodes are locations in the device that are used to calculate displacement vector, and reaction force. The nodes include nodes within the substrate, the electrode, and nodes on top and bottom boundaries. The matrix equation (42) can be further simplified by eliminating the third row to become equation (43) below

$$[ \begin{matrix}{K}_{II} & {K}_{IA} + ζ {K}_{IB} \\ SYM & {K}_{AA} + {K}_{BB}\end{matrix} ] [ \begin{matrix}{U}_{I} \\ {U}_{A}\end{matrix} ] = {w}^{2} [ \begin{matrix}{M}_{II} & {M}_{IA} + ζ {M}_{IB} \\ SYM & {M}_{AA} + {M}_{BB}\end{matrix} ] [ \begin{matrix}{U}_{I} \\ {U}_{A}\end{matrix} ] \qquad ( 43 )$$

where SYM represent symmetric (symmetric along diagonal lines) elements of the matrixes in equation (43). Equation (43) is in a form of eigen value problem. For a periodic structure of FIG. 3A, the boundary conditions are listed below.

U_{B}(x=d)=ζU_{A}(x=0) (44)

R_{B}(x=d)=−ζR_{A}(x=0)

ζ=(−1)

where

on the planes x=0, d.

For the combined effects of residual stress and temperature, a static analysis prior to the eigenvalue analysis must be performed to obtain strain measure Eₘₙ in equation (38) by following the FE procedure. If the change in temperature, ΔT, is known, the strain due to different material expansion coefficients can be considered as an initial strain, ε₀, which can be represented by equation (45). From the theory of mechanics of solids, only three principal axes strains are non-zero for thermal expansion due to temperature change, ΔT.

ε₀={εₒ εₒ εₒ 0 0 0}^{T}={αΔT αΔT αΔT 0 0 0}^{T} (45)

where α is the thermal expansion coefficient. Accordingly, the stress due to initial strain can be obtained by using equation (46) below.

σ=C(ε−εₒ) (46)

The strain energy for FE equation can be obtained from equation (47) below.

$$Ψ = \frac{1}{2} {\int }_{V}^{ } ( ɛ - {ɛ}_{0} ) C ( ɛ - {ɛ}_{0} ) d V \qquad ( 47 )$$

A Galerkin procedure can be applied to equation (47) to yield a FE matrix equation (48) for solving displacement d, from which strain Eₘₙ can be obtained.

Kd=f where K=∫B^{T}CBdV f=∫B^{T}Cε₀dV (48)

It should be appreciated that equation (31) is different from the strain density developed for the analysis of temperature-frequency behavior of equation (19). Equation (31) includes the effect of temperature and residual stress. In contrast, equation (19) only includes the temperature effect and the left hand side of equation (30) only includes residual stress effect. Solving equations (19) and (30) separately to obtain eigen values independently first, and then superimposing the solved eigen values together to obtain the effects of both temperature and residual stress take multiple simulation steps and are more time consuming. The present invention proposes solving equation (39), or (43), with combined effects to obtain only one set of eigenvalues (ω) and corresponding eigenvectors in one single step. The obtained eigenvalues can be used to calculate frequencies and the eigenvectors can be used to calculate displacements of the SAW/LSAW device.

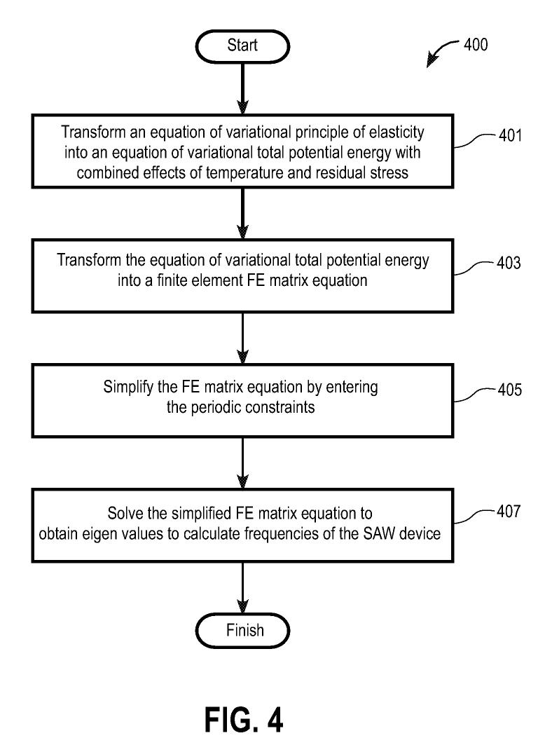

FIG. 4 shows a process flow 400 for obtaining the frequencies and displacements of SAW/LSAW devices. At operation 401, an equation of variational principle of elasticity is transformed into an equation of variational total potential energy with combined effects of temperature and residual stress. In one embodiment, the equation of variational principle of elasticity is represented by equation (13) and the equation of variational strain energy density is represented by equation (38). At operation 403, the equation of variational strain energy density is transformed into a finite element (FE) matrix equation. The FE matrix equation is represented in equation (39). The size of the matrix equation to solve is heavily dependent on the FE discretization, which will generate FE nodes and elements over the problem geometry domain. At this operation, the value of temperature is entered and the various coefficients in equation (39) are also entered based on materials used in the numerical analysis, such as the materials for electrode(s), the substrate, and the adhesive material, under the temperature. At operation 405, the periodic constraints are entered to simplify the FE matrix equation. The simplified form is as shown in equation (43). At operation 407, the simplified FE matrix equation (equation 43) is solved to obtain eigen values. After the eigen values are obtained, the frequencies and/or displacements of the SAW/LSAW devices are solved.

As mentioned above, the simulation of a SAW (or LSAW) device uses the Finite Element (FE) method to solve the governing equations. The FE method involves creating a mesh. The mesh elements should be small enough to effectively simulate the behavior of the SAW device, which could require a large amount of computational resources. However, the time it takes to finish the computation should be acceptable to meet engineering demands.

Solving the matrix equation, such as equation (43), with combined effects eliminates multi-step procedure to obtain the effects of temperature and residual stress on the device. It should be appreciated that for SAW and LSAW devices that have high operating frequencies, using the finite element method described above that takes temperature effects into consideration results in more accurate results. In addition, during the preparation of SAW/LSAW devices, the devices are subject to different thermal cycling, which would result in residual stress on the devices. Using the finite element method described above that takes the effect of residual stress into consideration results in more accurate results. The sources of residual stress, which results in initial deformation, are not limited to thermal cycling. For example, pre-applied external forces can also introduce residual stress.

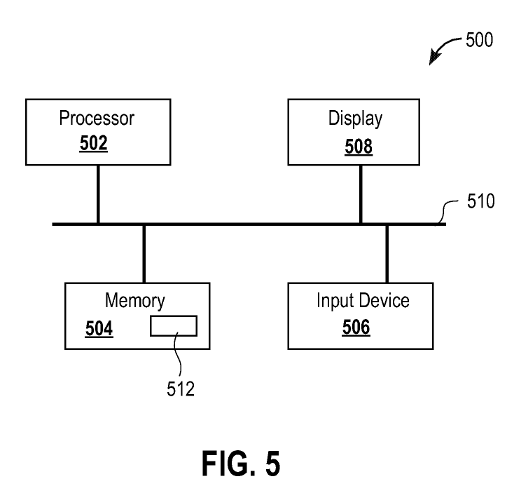

One skilled in the art will appreciate that the functionality described above for simulating a SAW on a corrugated structure may be incorporated into a computer readable medium for use in a computer system. FIG. 5 is a simplified block diagram of a high level overview of a computer system for simulating a SAW on a structure, in accordance with one embodiment of the present invention. As shown in FIG. 5, computer system 500 includes processor 502, display 508 (e.g., liquid crystal (LCD) displays, thin-film transistor (TFT) displays, cathode ray tube (CRT) monitors, etc.), memory 504 (e.g., static access memory (SRAM), dynamic random access memory (DRAM), hard disk drives, optical disc drives, etc.), and input device 506 (e.g., mouse, keyboard, etc.). Each of these components may be in communication through common bus 510. In one exemplary embodiment, an analysis program 512 stored in memory 504 and executed by processor 502 includes program instructions for applying the hybrid method to a periodic structure and program instructions for solving a set of equations simultaneously to obtain numerical results.

In the illustrated system, all major system components connect to bus 510 which may represent more than one physical bus. However, various system components may or may not be in physical proximity to one another. For example, input data and/or output data may be remotely transmitted from one physical location to another. Also, programs that implement various aspects of this invention may be accessed from a remote location (e.g., a server) over a network. Such data and/or programs may be conveyed through any of a variety of machine-readable media. Machine-readable media are divided into two groups, one being storage medium and the other being transmission medium. Storage medium includes magnetic tape or disk or optical disc. Transmission medium includes any other suitable electromagnetic carrier signals including infrared signals.

The present invention may be conveniently implemented with software. However, alternative implementations are certainly possible, including a hardware and/or a software/hardware implementation. Any hardware-implemented functions may be realized using ASIC(s), digital signal processing circuitry, or the like. The term “machine-readable medium” as used herein includes software, hardware having a program of instructions hardwired thereon, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

The embodiments of the present invention provide methods and systems for simulating a SAW and/or an LSAW device, while taking into account the temperature and residual stress of the device into consideration. The simulation involves transforming an equation of variational principle of elasticity into an equation of variational strain energy density by taking the effects of temperature and residual stress into account. The transformation considers frequency-temperature relation and the effect of initial deformation caused by residual stress. In one embodiment, the residual stress is a result of thermal cycling on the SAW or LSAW device. The equation of variational strain energy density is then transformed into a finite element equation by considering the periodic constraints of the SAW or LSAW device. The finite element equation is then solved to obtain eigen values and frequencies of the SAW or LSAW device. By considering the effects of stress and residual stress simultaneously during equation transformation, solving the eigen values and frequencies of the SAW or LSAW device is a single step process, instead of a multi-step process. Further, the results are more accurate due to considering the combined effects of temperature and residual stress.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for simulating a surface acoustic wave in a waveguide, comprising operations of:
transforming an equation of variational principle of elasticity into an equation of variational total potential energy with combined effects of temperature and residual stress;
transforming the equation of variational total potential energy into a finite element (FE) equation;
simplifying the FE equation by using periodic constraints of the waveguide;
solving the simplified FE equation to obtain eigen values; and
calculating a frequency of the waveguide by using the obtained eigen values.

2. The method of claim 1, wherein the periodic constraints of the waveguide assume each section of the waveguide under an electrode is identical to the neighboring sections.

3. The method of claim 1, further comprising:
performing a static analysis to obtain strain measure by following a FE procedure prior to transforming the equation of variational strain energy density into the finite element equation.

4. The method of claim 1, wherein the residual stress is a result of thermal cycling of the waveguide and mismatch of thermal coefficients of electrodes of the waveguide, a substrate of the waveguide, the support of the waveguide.

5. The method of claim 1, wherein the waveguide has an array of electrode, and the array of electrodes is made of a material selected from a group consisting of aluminum, copper, gold, and conducting polymers.

6. The method of claim 1, wherein a substrate of the waveguide is made of a material selected from a group consisting of quartz (SiO₂), barium titanate (BaTiO₃), lithium tantalate (LiTaO₃), lithium niobate (LiNbO₃), gallium arsenide (GaAs), silicon carbide (SiC), langasite (LGS), zinc oxide (ZnO), aluminum nitride (AlN), lead zirconium titanate (PZT), and polyvinylidene fluoride (PVdF).

7. The method of claim 1, wherein a material for a support for the waveguide is either a butadiene polymer or a silicon polymer.

8. The method of claim 6, wherein the substrate is an anisotropic piezoelectric crystalline solid.

9. The method of claim 1, wherein the transforming of the equation of variational principle of eleasticity into the equation of variational total potential energy with combined effects of temperature and residual stress eliminates multi-step procedure to obtain the combined effects of temperature and residual stress on the waveguide.

10. The method of claim 1, wherein the constants of the finite element equation takes the effects of temperature and materials into consideration.

11. The method of claim 1, wherein a geometry and a mesh for FE analysis of the waveguide are defined prior to solving the simplified finite element equation to obtain the eigen values.

12. A method for simulating a surface acoustic wave in a waveguide, comprising operations of:
transforming an equation of variational principle of elasticity into an equation of variational total potential energy with combined effects of temperature and residual stress;
transforming the equation of variational total potential energy into a finite element (FE) equation, wherein a static analysis is performed to obtain strain measure by following a FE procedure prior to transforming the equation of variational total potential energy into the FE equation;
simplifying the FE equation by using periodic constraints of the waveguide;
solving the simplified finite element equation to obtain eigen values, wherein a geometry and a mesh for FE analysis of the waveguide are defined prior to solving the simplified FE equation to obtain the eigen values; and
calculating a frequency of the waveguide by using the obtained eigen values.

13. The method of claim 12, wherein sources of the residual stress are at the interface between the electrodes and the substrate, and the interface between the substrate and the support.

14. The method of claim 12, wherein the transforming of the equation of variational principle of eleasticity into the equation of variational total potential energy is performed by utilizing the divergence theorem and stress-strain relation.

15. The method of claim 12, wherein the periodic constraints of the waveguide assume each section of the waveguide under an electrode is identical to the neighboring sections.

16. A machine-readable medium having a program of instructions for simulating a surface acoustic wave in a waveguide with combined effects of temperature and residual stress, the program of instruction comprising:
program instructions for transforming an equation of variational principle of elasticity into an equation of variational total potential energy with combined effects of temperature and residual stress;
program instructions for transforming the equation of variational total potential energy into an finite element equation;
program instructions for simplifying the finite element equation by using periodic constraints of the waveguide;
program instructions for solving the simplified finite element equation to obtain eigen values; and
program instructions for calculating a frequency of the waveguide by using the obtained eigen values.

17. The machine-readable medium of claim 16, wherein the periodic constraints of the waveguide assume each section of the waveguide under an electrode is identical to the neighboring sections.

18. The machine-readable medium of claim 16, wherein residual stress is a result of thermal cycling of the waveguide and mismatch of thermal coefficients of electrodes of the waveguide, a substrate of the waveguide, a support of the waveguide.

19. The machine-readable medium of claim 16, further comprising:
program instructions for performing a static analysis to obtain strain measure by following a FE procedure prior to transforming the equation of variational total potential energy into the finite element equation.

20. The machine-readable medium of claim 16, wherein a geometry and a mesh for FE analysis of the waveguide are defined prior to solving the simplified finite element equation to obtain the eigen values.
